(19) United States
(12) Patent Application Publication
(10) Pub. No.: US 2007/0112607 A1
(43) Pub. Date: May 17, 2007

(54) Score-based alerting in business logic

(75) Inventors: Ian Tien, Seattle, WA (US); Chen-I Lim, Bellevue, WA (US); Corey J. Hulen, Sammammish, WA (US); Zhenyu Tang, Sammammish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/280,548

(22) Filed: Nov. 16, 2005

(51) Int. Cl. G06F 9/44

(52) U.S. Cl. 705/7

(57) ABSTRACT

Score-based alerting is provided in a business logic application to provide summary status information on heterogeneous measures such as KPI's and Objectives, which are derived from aggregated KPI's, for monitoring organizational performance. Criteria for alerts are based on comparison of raw data to threshold values, trends of aggregated scores, and comparisons of aggregated scores to threshold values or ranges. Alert criteria are dynamically modified when score calculation parameters are modified. Alerts can be selected from a template by a subscriber across different levels of aggregated scores, scoring methods, and user-defined criteria.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Key Performance Indicators are quantifiable measurements that reflect the critical success factors of an organization. Their use may differ depending on the organization. For example, large organizations may monitor a wide variety of measures from employee satisfaction to local sales figures. A business logic application collecting data for the performance measures and performing calculations may provide reports at different levels of combination, schedule, granularity, and the like. The task of providing reports is relatively complex when the performance measures are of different nature. For example, a school may focus a KPI on the graduation rates of its students while a social service organization might use the number of clients assisted during a year as performance indicator. The task of reporting is further complicated by different users needing different reports with diverse schedules, reporting criteria, and the like.

### SUMMARY

Score-based alerting provides summary status information on heterogeneous measures (e.g. KPI's) and aggregations of heterogeneous measures (e.g. Objectives) for monitoring organizational performance. Alerts may be selected from a template by a subscriber across different levels of aggregated scores, scoring methods, and user-defined conditions. Conditions for alerts may be based on comparison of raw data to threshold values, trends of aggregated scores, comparison of aggregated scores to threshold values or ranges, and the like. Alert conditions may be dynamically modified when score calculations are modified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a business logic application may be executed using score-based alerting;

FIG. 2 illustrates a system, where example embodiments of score-based alerting may be implemented;

FIG. 3 illustrates an example scorecard architecture according to embodiments;

FIG. 4 illustrates a screenshot of an example scorecard;

FIG. 5 illustrates boundary selection in a scorecard application using text boxes and sliders, and relationship of boundary sliders with indicator ranges in boundary preview;

FIG. 6 illustrates an example scorecard with different alert columns;

FIG. 7 illustrates a screenshot of a score-based alert publication;

FIG. 8 illustrates a screenshot of a user interface for editing score-based alert parameters;

FIG. 9 illustrates two screenshots of a wizard user interface for editing score-based alert parameters;

FIG. 10 illustrates a screenshot of a user interface for editing score-based alert scheduling;

FIG. 11 illustrates examples of page-filtering feature of a score-based alerting application; and

FIG. 12 illustrates a logic flow diagram for a process of score-based alerting in a business logic application.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

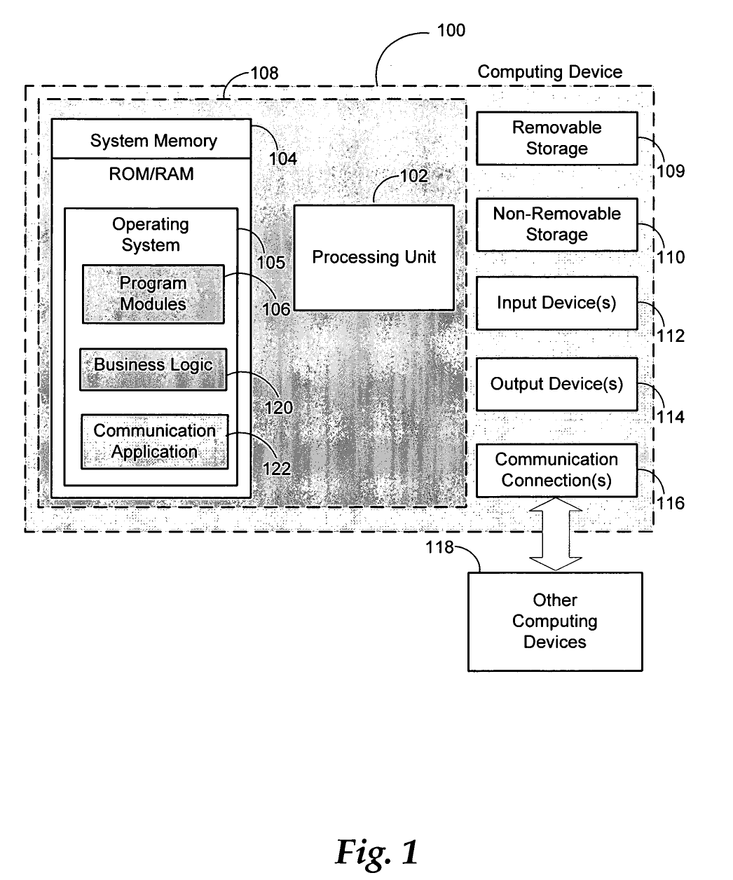

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, business logic application 120 may also be executed within operating system 105. Business logic application 120 may include a scorecard application or any similar application to manage business evaluation methods. Business logic application 120 may interact with communication application 122 to provide score-based alerts derived from evaluation of performance measures.

To perform the actions described above, business logic application 120 and communication application 122 may include and/or interact with other computing devices, applications, and application interfaces (APIs) residing in other applications.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

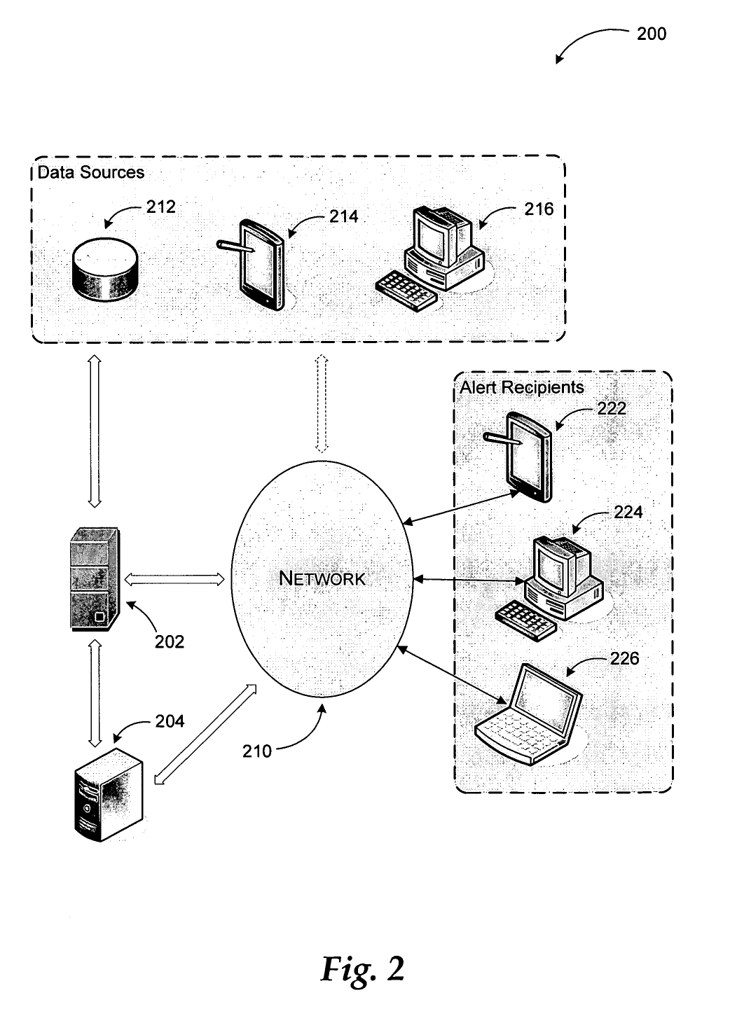

FIG. 2 illustrates system 200, where example embodiments of score-based alerting may be implemented. System 200 may comprise any topology of servers, clients, Internet service providers, and communication media. Also, system 200 may have a static or dynamic topology.

A business logic application may be run centrally on server 202 or in a distributed manner over several servers (e.g. servers 202 and 204) and/or client devices. Server 202 may include implementation of a number of information systems such as performance measures, business scorecards, and exception reporting. A number of organization-specific applications including, but not limited to, financial reporting, analysis, booking, marketing analysis, customer service, and manufacturing planning applications may also be configured, deployed, and shared in system 200.

Data sources 212, 214, and 216 are examples of a number of data sources that may provide input to server 202. Additional data sources may include SQL servers, databases, non multi-dimensional data sources such as text files or EXCELS sheets, multi-dimensional data source such as data cubes, and the like.

Users may interact with server 202 running the business logic application from client devices 222, 224, and 226 over network 210. In one embodiment, users may receive score-based alerts from server 202 through client devices 222, 224, and 226.

Network 210 may be a secure network such as an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

Many other configurations of computing devices, applications, data sources, data distribution and analysis systems may be employed to implement a business logic application with score-based alerting.

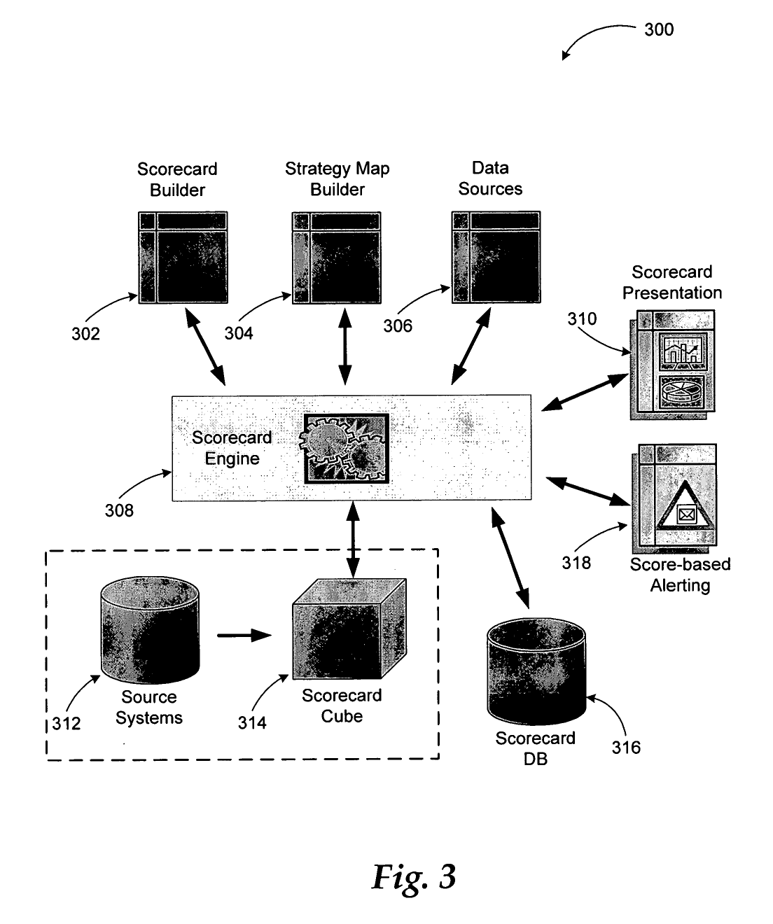

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application software that is arranged to evaluate performance metrics. Scorecard engine 308 may be loaded into a server, executed over a distributed network, executed in a client device, and the like.

Data for evaluating various measures may be provided by a data source. The data source may include source systems 312, which provide data to a scorecard cube 314. Source systems 312 may include multi-dimensional databases such as an Online Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)-accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like.

Furthermore, scorecard architecture 300 may include score-based alerting 318. Score-based alerting 318 may include a communication application that is arranged to provide alerts in form of electronic messaging, instant messaging, facsimile, and the like to users based on predetermined criteria for score status.

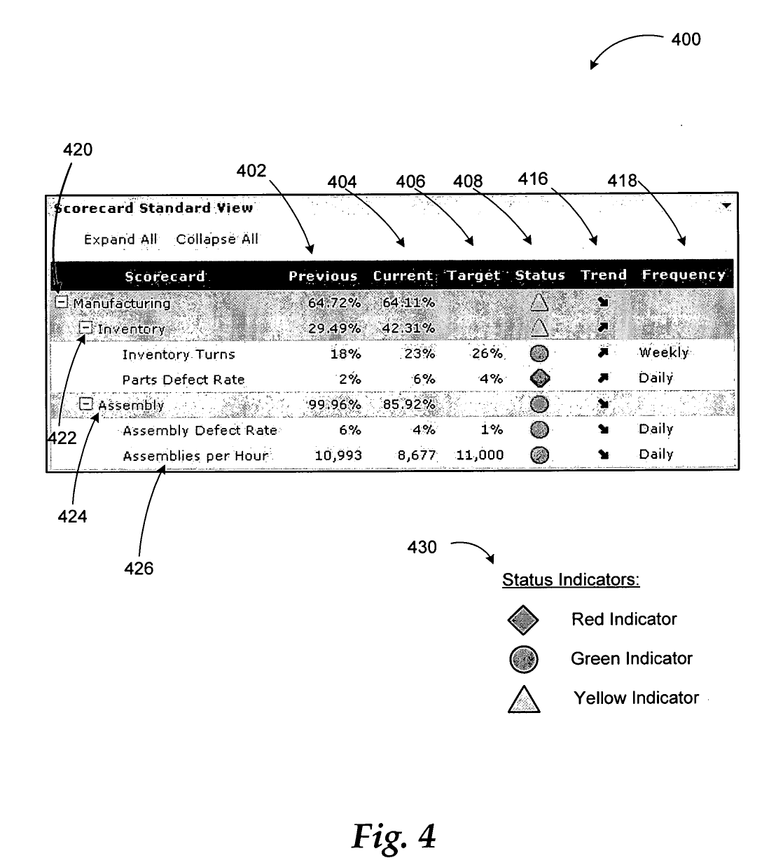

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

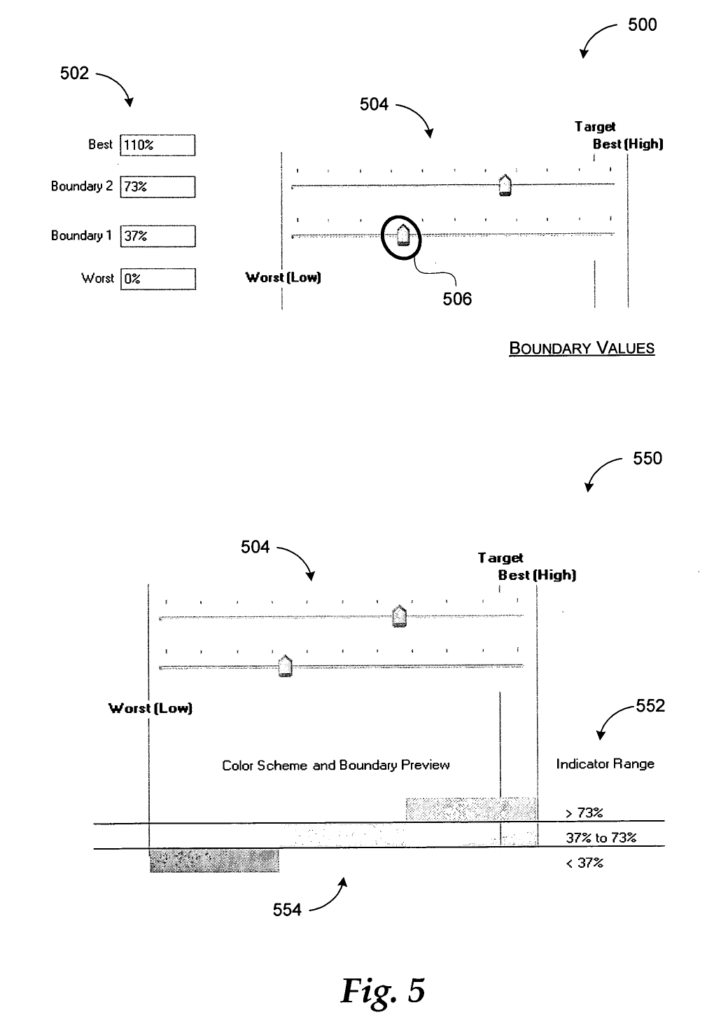

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands as described below in conjunction with FIG. 5.

Column 416 includes trend type arrows as explained above under KPI attributes. Column 418 shows another KPI attribute, frequency.

FIG. 5 illustrates boundary selection in a scorecard application using text boxes and sliders, and relationship of boundary sliders with indicator ranges in boundary preview.

The user is provided with an option to use sliders to manipulate the boundary values or to manually enter them. In some embodiments, there may be more than one lower and upper boundary values (e.g. Closer To Target Is Better). The controls for entering Boundary Values are shown in user interface 500. When a user drags the slider (e.g. slider 506) in slider region 504 of the user interface, the values in the text boxes of text box region 502 are changed to reflect the current position of the slider. Conversely, when a boundary is manually entered into the text box the sliders are automatically adjusted to the correct position to reflect the change.

The number of sliders displayed is equal to the number of boundaries for the selected Indicator. In the case when there is more than one boundary value, the sliders restrict the user from overlapping boundaries. For example, if Boundary 1's slider is dragged to the right past Boundary 2's slider, Boundary 2's slider is automatically updated to be at the same position as Boundary 1's slider. This update is also reflected in the Boundary 2's text box. Following the same behavior of restricting overlapping with the sliders, if a boundary value is entered past another in the text box, the overlapped boundary value is changed.

The sliders and text boxes are not the only objects whose behavior is linked together. When the slider is moved, the changes are also reflected in the Boundary Preview and the Indicator Range regions as shown in user interface 550. The boundaries may be depicted by a change in color and level in Boundary Preview chart 554. As shown in user interface 550, the boundaries are depicted directly below slider region 504.

When a user drags a slider, the corresponding boundary is moved to reflect the change in slider position. The values under Indicator Range 552 are also updated to reflect the boundary changes and depict the correct values for the range. For example, in user interface 550 the lighter colored bar (indicating acceptable but potentially problem status) grows and the darker colored bar (indicating acceptable status) gets shorter, if the upper boundary is moved to the right to 80%. The 73% value in the Indicator Ranges is also changed to 80%.

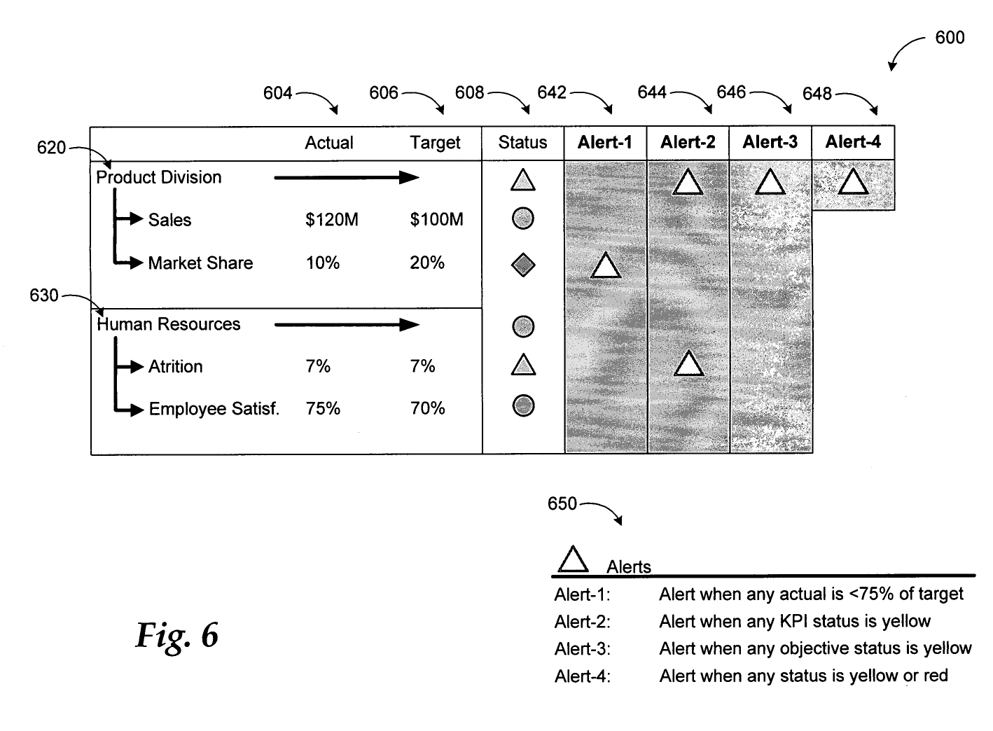

FIG. 6 illustrates an example scorecard with different alert columns. Scorecard 600 includes two top level objectives for an organization. Objective 620 is performance for “Product Division.” Objective 630 is performance for “Human Resources.” Each objective had two KPI's reporting to them. “Sales” and “Market Share” report to “Product Division”, while “Attrition” and “Employee Satisfaction” report to “Human Resources.” Column 604 includes actual values of an example period for each of the KPI's. Column 606 includes target values in the example period for the KPI's.

Column 608 is a status column including status indicators according to a traffic light scheme where three status indicators are assigned to different comparison ranges. For example, green (round) status indicator may be assigned when the actual is equal or above the target value; yellow (triangle) status indicator may be assigned when the actual is between 75% and 100% of the target value; and red (diamond) status indicator may be assigned when the actual is less than 75% of the target value.

While scorecard 600 is shown with a single score column (608), additional columns may be used in other embodiments. Each score column may include a different score type such as percent comparison, absolute comparison, range comparison, and the like. Furthermore, scorecards may include any number of KPI's, objectives and goals with any hierarchical relationship. Each score column does not have to have a score for all of the KPI levels. Scores may be assigned to selected levels in each of the score columns. Some score columns may also indicate a trend of a score from another column or a trend of an actual value in comparison to the target value.

The scores may be calculated based on a multi-dimensional data source, a user input, or an analytical data model.

Columns 642-648 are example alert columns. Alerts with different conditions may be assigned to the same scores or to different scores. Moreover, alerts may be specific to individual levels, aggregate levels (e.g. objectives), any levels, or scorecard level. Alerts may be based on absolute value comparisons (e.g. actual to target, actual to a threshold, and the like), status indicators (e.g. traffic light scheme, banding, trend scheme), range comparisons (e.g. actual or actual to target ratio within a range, outside a range, and the like), or on/off target determinations.

Alerts may also be based on transitions of scores in one direction or in any direction (e.g. when status changes from green to yellow or when actual changes from on-target in any direction). Additionally, alerts may also be determined based on a predetermined combination of conditions or other alerts.

Specific example alerts in columns 642-648 are listed in table 650. The condition for Alert-1 is when any actual is less than 75% of target value. The condition for Alert-2 is when any KPI status is yellow. The condition for Alert-3 is when any objective status is yellow. The condition for Alert-4 is when any status is red or yellow.

Alerts may also be issued when a calculation parameter for a score (e.g. boundary values or target value). In one embodiment, the condition for the alert may be dynamically modified if one of the score calculation parameters is changed.

Other scorecard presentations, alert types, status indicators, and the like may be implemented using the principles described herein.

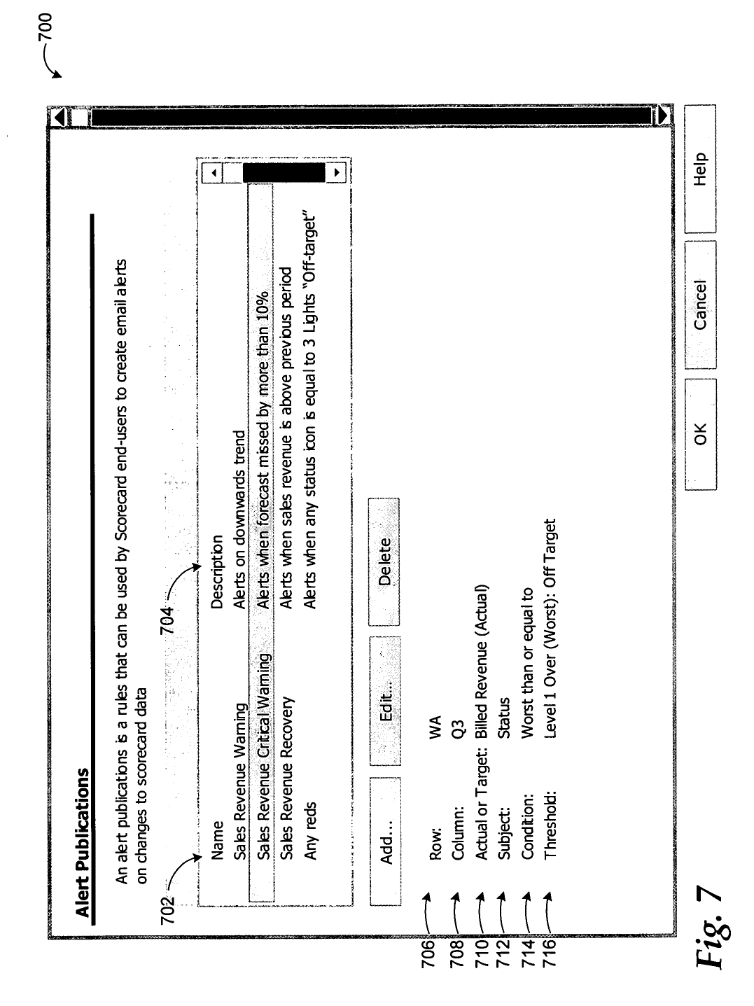

FIG. 7 illustrates a screenshot of an example score-based alert publication. As described above, scorecards may include multiple levels of hierarchically structured scores and multiple columns reflecting different actuals, targets, and their respective scores. Furthermore, alerts may be based on different conditions for the same score. Accordingly, a number of alerts may be set up for the same score set in a scorecard. For ease of distinguishing, alerts may be assigned names in one embodiment.

In screenshot 700, Name 702 is a list of existing alerts with a corresponding description of the alert in Description 704. For example, three different alerts may be set up based on the sales revenue scores. First alert, “Sales Revenue Warning”, is triggered by a downward trend in sales revenue. Second alert, “Sales Revenue Critical Warning”, is issued when sales revenue forecast is missed by more than 10%. The third alert, “Sales Revenue Recovery”, is triggered by sales revenue exceeding the revenue of a previous period.

In one embodiment, the alerts listed under Name 702 may be part of a default template and the subscriber may be presented with an opportunity to select from the default alerts, edit and modify the default alerts, remove existing alerts, or add new alerts.

The “Alert Publications” screen may further provide detail information about each of the alerts. For example, row 706 refers to a specific KPI or objective in the scorecard, column 708 refers to a specific column in a multi-column scorecard (such as different quarters of a fiscal year evaluation on the same scorecard). Actual or Target 710 refers to a selected source for the alert condition. Subject 712 refers to the score type that is to be used in the alert condition (in the example, a status indicator is selected). Condition 714 refers to the criterion that is applied to the score for the alert to be issued. In the example alert, the condition is the status being worse than or equal to the target value. Thus, an alert is issued if billed revenue actual is equal to the target revenue or falls below the target revenue.

Threshold 716 indicates a threshold value, if the condition is based on a comparison of the actual value to a threshold. Threshold 716 may include an upper limit, a lower limit, a range, or a target value.

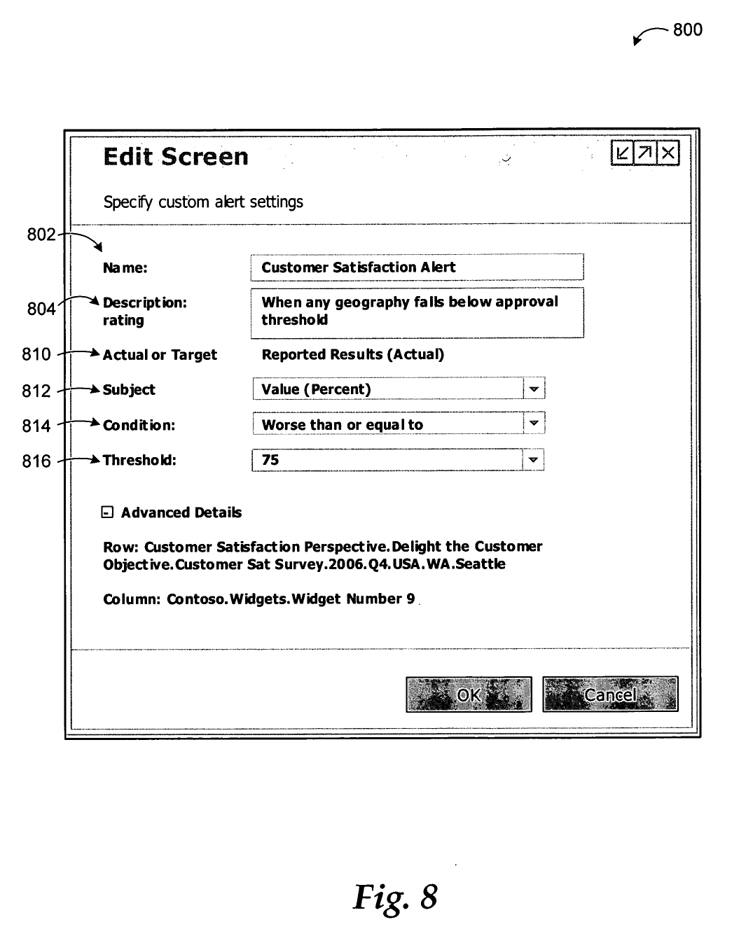

FIG. 8 illustrates a screenshot of a user interface for editing score-based alert parameters. Screenshot 800 shows a user interface screen for customizing score-based alert settings.

A subscriber can specify a name for the alert in Name box 802, for example, “Customer Satisfaction Alert.” A description may be provided in Description box 804 characterizing the alert. Actual or Target box 810 specifies to the subscriber a source for alert condition, for example, “Reported Results (Actual).”

A type of score to be used in testing alert condition is specified in Subject box 812. Examples for Subject box 812 include value (percent), value (absolute), status, and the like. Condition box 814 is used to specify the condition for the alert. In conjunction with the contents of Subject box 812 and Threshold box 816, the condition determines whether the alert is to be issued or not. Threshold box 816 is for specifying a comparison value for the condition. In the example of screenshot 800, the condition compares an actual value to an approval threshold value, and issues the alert if the reported actual falls below 75% of the approval threshold value.

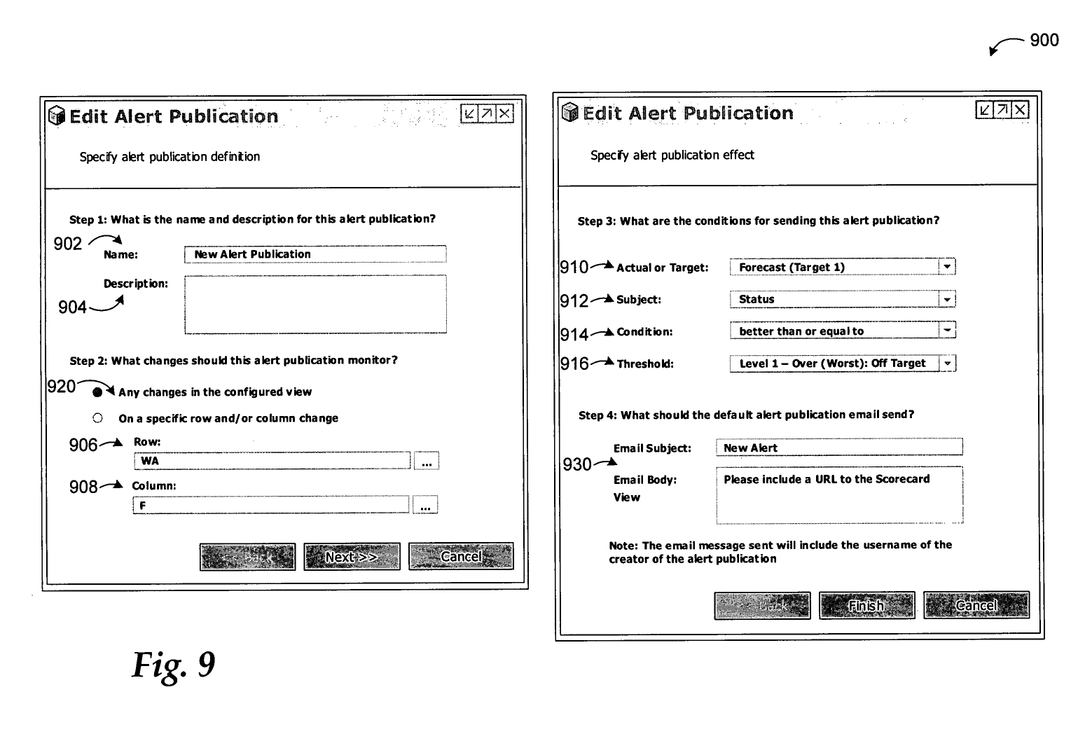

FIG. 9 illustrates two screenshots of a wizard user interface for editing score-based alert parameters. Screenshot 900 shows a wizard style user interface screen for customizing score-based alert settings.

The wizard style user interface for customizing score-based alert settings performs similar tasks to the user interface of FIG. 8. In fact, Name box 902, Description box 904, Actual of Target box 910, Subject box 912, Condition box 914, Threshold box 916 operate in a similar manner to the like-numbered boxes in screenshot 800 of FIG. 8. In addition to the above listed boxes, selection buttons 920 enable the subscriber to specify whether or not customization is to be made in any row or column (KPI or score). If changes are to be made, Row box 906 and column box 908 are used to indicate the row and the column to be selected for customization.

Email settings 930 prompt the subscriber to specify a subject line and any special parts in an email that is to be used to issue the alert. In other embodiments, an instant message, a text message, a facsimile, and the like may be used to issue the alert and their settings accordingly specified in the editor user interface.

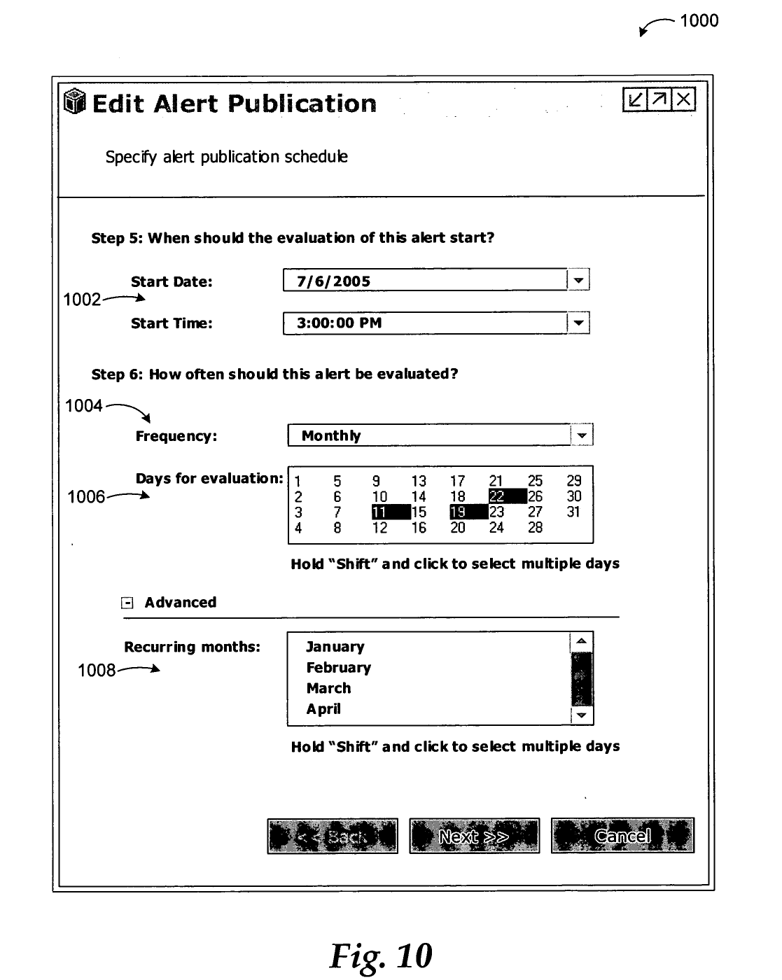

FIG. 10 illustrates a screenshot of a user interface for editing score-based alert scheduling. An alert scheduling user interface may be part of a broader editing user interface in wizard style or a standalone user interface enabling subscribers to select and modify scheduling of the alerts. Screenshot 1000 shows an example of a wizard style user interface for scheduling alerts.

Period specification 1002 prompts the subscriber to enter a start date and time for determining and issuing the alerts. Frequency 1004 prompts the subscriber to specify a frequency of scorecard evaluation for alert determination. Frequency 1004 may include any interval (e.g. monthly, weekly, daily, etc.). Days for evaluation 1006 enables the subscriber to identify selected days of the time interval specified by frequency 1004 when a scorecard is to be evaluated for alerts. For example, a school administration may want to evaluate student absences during the first and last Mondays and Fridays of each month. An interactive calendar may be provided to enable the subscriber to select among available days.

Recurring months 1008 may be an advanced scheduling tool enabling the subscriber to select among months of a year. For example, a seasonal business may select the months of the year when the business is open for score-based alerting. In other embodiments, scheduling parameters such as start date, frequency, and the like may be replaced with subscriber defined specific times. In further embodiments, alert schedules may be non-periodic.

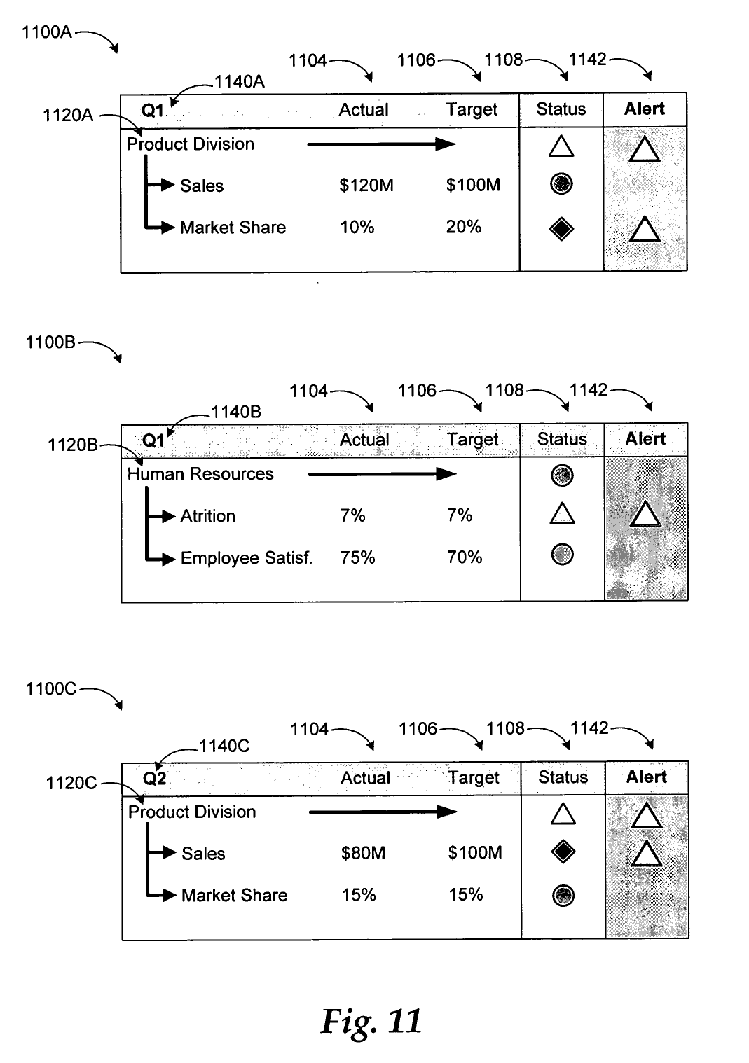

FIG. 11 illustrates examples of page-filtering feature of a score-based alerting application. Scorecard 1100A is an example scorecard reflecting scores and an alert status for an organization with two KPI levels. As described previously in conjunction with FIG. 6, top level objective 1120A is for “Product Division” of a company. Reporting to objective 1120A are KPI's for “Sales” and “Market Share”. Columns 1104 and 1106 show actual and target values for the KPI's, respectively. Column 1108 shows status indicators for the KPI's as well as the objective using traffic light scheme. Column 1142 is an example alert column based on alert condition “Alert when any indicator is red or yellow”. Thus, column 1142 includes alerts for “Market Share” and the top level objective “Product Division.”

Differently from the scorecard of FIG. 6, scorecard 1100A also includes time qualifier 1140A, which indicates a fiscal period for the scores. In the example scorecard, time qualifier 1140A is “Q1” indicating the scores are calculated for a first quarter of the company's fiscal year.

Scorecard 1140B is an example of page-filtering, where the data source is modified to another organizational unit. While time qualifier 1140B is still for “Q1,” top level objective 1120B is not “Human Resources” with its reporting KPI's “Attrition” and “Employee Satisfaction.” Contents of columns 1104 and 1106 for actual and target values change accordingly to reflect the new KPI's data. Status indicators in column 1108 are also changed based on the new actual and target values. Boundary values for the status indicators (e.g. actual<95% of target: red, 95% of target<actual<105% of target: yellow, 105% of target<actual: green) may remain the same, adjusted dynamically, or modified by user input in different embodiments.

In the page-filtered scorecard 1100B, the alert condition for column 1142 is the same as in scorecard 1100A. Accordingly, there is a single alert for KPI “Attrition.”

Scorecard 1140C is another example of page-filtering, where the data source remains the same while time qualifier 1140C is modified to reporting period (“Q2” in this example). Top level objective 1120C and its reporting KPI's are still the same as in scorecard 1100A. Contents of columns 1104 and 1106 for actual and target values change accordingly to reflect the new data in second quarter. Status indicators in column 1108 are also changed based on the new actual and target values. As in scorecard 1100B, boundary values for the status indicators may remain the same, adjusted dynamically, or modified by user input in different embodiments.

In the page-filtered scorecard 1100C, the alert condition for column 1142 is the same as in scorecard 1100A. Accordingly, there are two alerts for top level objective and KPI “Sales.”

Page-filtering is not limited to the examples shown above. Source data maybe replaced without generating a new set of score-based alerts implementing the principles described herein.

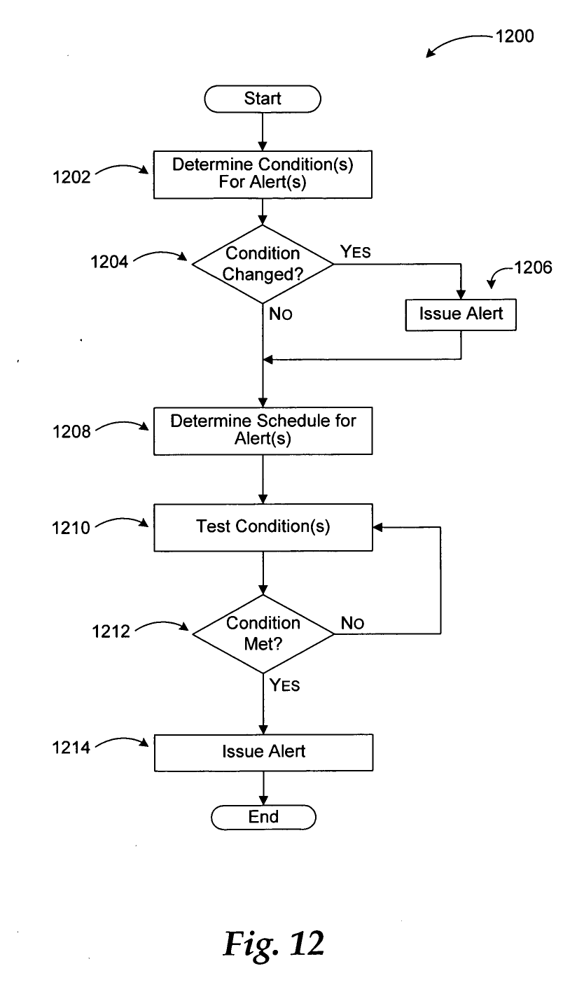

FIG. 12 illustrates a logic flow diagram for a process of score-based alerting in a business logic application.

Process 1200 begins at operation 1202, where a condition for a score-based alert is determined. As described previously, score-based alerts may be issued based on a number of scores at different levels of score hierarchy (e.g. KPI's, objective, goals, and the like) or across multiple columns of scores (e.g. different status indicators for the same set of scores). For each alert a condition is determined such as a status indicator being yellow, the actual being off-target, the actual being more than 90% below target, the status indicator transitioning from green to yellow, and the like. Processing moves from operation 1202 to decision operation 1204.

At decision operation 1204, a determination is made whether a score calculation parameter has changed. For example, a target value, boundary values for the status indicator, a threshold value for the status indicator, and the like, may be modified by a user other than the subscriber requesting the alert. In such a scenario, the subscriber may desire to receive an alert. If the score calculation parameter is changed, processing moves to operation 1206 where an alert is issued. Then processing advances to operation 1208. If the determination at decision operation 1204 is negative, processing moves directly to operation 1208.

At operation 1208, a schedule for the alert(s) is determined. The subscriber may specify the schedule as described in conjunction with FIG. 10, or accept default schedule times. Processing advances from operation 1208 to operation 1210.

At operation 1210, the condition(s) for the alert(s) is tested at the intervals specified by the schedule. For example, if the condition is “Alert when status indicator transitions from green to yellow,” the status indicator is checked for a current value and previous value. Processing advances from operation 1210 to decision operation 1212.

At decision operation 1212, a determination is made whether the condition is met. In the above example, the condition is met, if the status indicator has transitioned from green to yellow in the specified time period. If the condition is met, processing moves to operation 1214. Otherwise, processing returns to operation 1210 for further testing of the condition(s).

At operation 1214, the alert is issued. The alert may be presented to the subscriber, in form of an electronic mail, an instant message, a text message, a facsimile, and the like. After operation 1214, processing moves to a calling process for further actions.

The operations included in process 1200 are for illustration purposes. Providing score-based alerts in a business logic may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for providing a score-based alert, comprising:
determining a condition for the score-based alert based on at least one score, wherein the score is determined from a performance measure;
testing the condition; and
issuing the score-based alert when the condition is met.

2. The computer-implemented method of claim 1, wherein the score is one of: a Key Performance Indicator (KPI), an objective, and a goal.

3. The computer-implemented method of claim 1, wherein the condition is met if the score is one of: less than a threshold value, higher than a threshold value, within a range, outside a range, and substantially unequal to a target value (off-target).

4. The computer-implemented method of claim 1, further comprising issuing the score-based alert in response to one of: a predetermined status indicator for at least one score and a result of the condition transitioning from one value to another value.

5. The computer-implemented method of claim 1, further comprising issuing the score-based alert in response to a modification of at least one score calculation parameter.

6. The computer-implemented method of claim 1, further comprising dynamically modifying the condition in response to a modification of at least one score calculation parameter.

7. The computer-implemented method of claim 1, further comprising determining a schedule for testing the condition.

8. The computer-implemented method of claim 7, wherein the schedule for testing the condition is determined by one of: a default parameter and a user-defined parameter.

9. The computer-implemented method of claim 1, wherein a recipient of the score-based alert is provided with a template of a plurality of predetermined conditions such that the recipient selects among the conditions in the template and is provided with an opportunity to customize the selected conditions.

10. The computer-implemented method of claim 1, further comprising determining at least one additional score-based alert based on another condition, wherein the conditions are based on one of: the same score and different scores.

11. The computer-implemented method of claim 1, further comprising issuing the score-based alert in response to a change in a trend associated with the score.

12. The computer-implemented method of claim 1, wherein the score is calculated based on at least one of: a multi-dimensional data source, a user input, and an analytical data model.

13. The computer-implemented method of claim 1, further comprising issuing the score-based alert in response to testing a plurality of conditions associated with at least one score.

14. A computer-readable medium having computer instructions for a unified model providing score-based alerts in a business logic application, the instructions comprising:
determining at least one condition for a score-based alert based on a plurality of scores, wherein the scores are determined from hierarchically structured performance measures in a scorecard;
determining a schedule for testing the condition; and
testing the condition at an interval determined by the schedule;
issuing the score-based alert when the condition is met.

15. The computer-readable medium of claim 14, wherein the plurality of scores are determined from performance measures of at least one distinct hierarchy levels, and wherein the condition is based on scores from at least one scorecard column.

16. The computer-readable medium of claim 14, wherein the condition is met when the score is one of: less than a threshold value, higher than a threshold value, within a range, outside a range, and substantially unequal to a target value (off-target).

17. The computer-readable medium of claim 14, wherein the instructions further include providing a subscriber with a template of a plurality of default conditions such that the subscriber selects among the conditions in the template and is provided with an opportunity to customize the selected conditions and scheduling of the score-based alert.

18. A system for providing score-based alerts, the system comprising:
a database that includes data associated with performance evaluation measures;
a score-calculation engine configured to:
determine a condition for an alert based on at least one score, wherein the at least one score is determined from the hierarchically structured performance evaluation measures;
determine a schedule for testing the condition; and
test the condition at an interval determined by the schedule;
issue the alert when the condition is met; and
a communication application configured to provide the alert to a subscriber.

19. The system of claim 18, wherein the score-calculation engine is configured to test the condition by determining at least one of: a comparison of the score to one of a threshold value and a range, a comparison of the score to a target value, a temporal trend of the score, and a status indicator associated with the score.

20. The system of claim 18, wherein the communication application is configured to provide the alert to the subscriber as one of: an electronic mail, an instant message, a text message, and a facsimile.
